(19) United States
(12) Patent Application Publication
(10) Pub. No.: US 2015/0316372 A1
(43) Pub. Date: Nov. 5, 2015

(54) SYSTEM FOR OUTPUTTING DEGREE OF INCLINATION OF ELECTRONIC DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: PENG ZHANG, Wuhan (CN)

(21) Appl. No.: 14/542,168

(22) Filed: Nov. 14, 2014

(30) Foreign Application Priority Data
Apr. 30, 2014 (CN) 201410179574.X

(51) Int. Cl. G01C 9/06

(52) U.S. Cl. CPC G01C 9/06; G01C 2009/062; G01C 2009/066

(57) ABSTRACT

A system includes a frequency signal generator, a capacitor sensor, a frequency-voltage converter, and a degree of inclination displaying device. The capacitor sensor can be attached to an electronic device and includes a variable capacitor having a capacitance which varies in dependence upon a degree of inclination of the electronic device. The frequency signal generator outputs a frequency signal to the frequency-voltage converter. The capacitor sensor outputs a capacitor signal to the frequency-voltage converter. The frequency-voltage converter outputs a voltage signal to the degree of inclination displaying device according to the frequency signal and the capacitor signal. The degree of inclination displaying device obtains the degree of inclination of the electronic device according to the voltage signal and displays the degree of inclination.

### CROSS-REFERENCE TO RELATED APPLICATIONS

This application claims priority to Chinese Patent Application No. 201410179574.X filed on Apr. 30, 2014, the contents of which are hereby incorporated by reference.

### FIELD

The disclosure generally relates to indicating systems, and more particularly relates to systems for outputting a degree of inclination of an electronic device.

### BACKGROUND

Televisions and other displays and monitors are often wall mounted or placed on a support of some type. In order to provide users with an optimal viewing angle, many of these devices are equipped with an angle adjustable stand or mounting apparatus. However, the conventional mechanism does not provide a way to allow the users to know a degree of inclination of the device.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is a block diagram of an embodiment of a system for outputting a degree of inclination of an electronic device.

FIG. 2 is a circuit diagram of an embodiment of the system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein. It should be noted that references to “an” or “one” embodiment in this disclosure are not necessarily to the same embodiment, and such references can mean “at least one.”

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

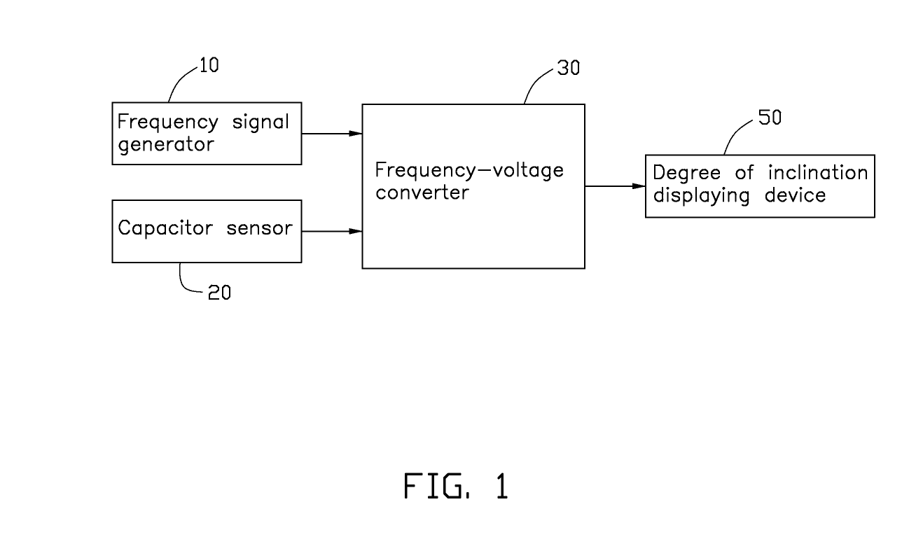

FIG. 1 illustrates a block diagram of an embodiment of a system for outputting a degree of inclination of an electronic device (not shown). The electronic device can be, but is not limited to, a monitor, a tablet computer, an all-in-one (AIO) computer, a smartphone, a personal digital assistant (PDA), a gaming device, a television set, or any other type of electronic device.

As is illustrated, the system can include a frequency signal generator 10, a capacitor sensor 20, a frequency-voltage converter 30, and a degree of inclination displaying device 50.

The capacitor sensor 20 can include a variable capacitor. The capacitor sensor 20 can be attached to the electronic device. When the electronic device is actuated to adjust its degree of inclination, the capacitance of the variable capacitor can vary in dependence upon the degree of inclination of the electronic device. When the electronic device stands upright relative to a horizontal direction, the capacitance of the variable capacitor can reach a minimum value. As the degree of inclination of the electronic device increases, the capacitance of the variable capacitor becomes greater. In some embodiments, the variable capacitor is a rotary capacitor.

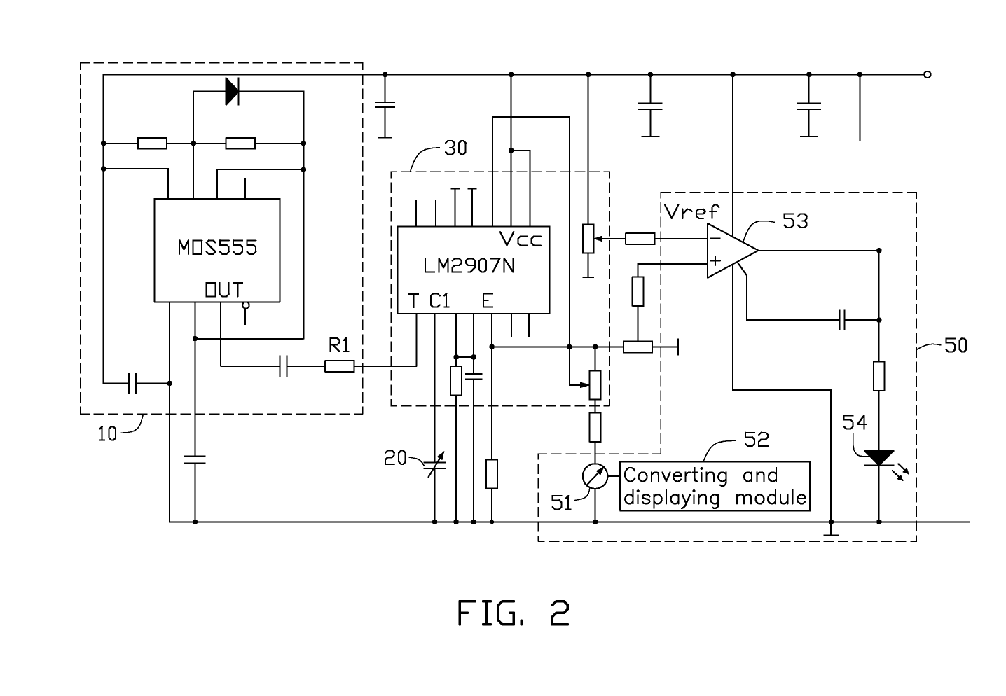

FIG. 2 illustrates a circuit diagram of an embodiment of the system of FIG. 1. The frequency signal generator 10 can include a time-base integrated circuit (IC) chip. As illustrated in FIG. 2, a model of the time-base IC chip can be a MOS555 chip. The MOS555 chip is used in a variety of timer, pulse generation, and oscillator applications. The MOS555 chip includes an output pin OUT. The output pin OUT can output a frequency signal to the frequency-voltage converter 30.

The model of the frequency-voltage converter 30 can be a LM2907N chip. The LM2907N chip includes a frequency signal input pin T, a capacitor signal input pin C1, a voltage signal output pin E, and an operating voltage input pin Vcc. The frequency signal input pin T is connected to the frequency signal generator 10 via a resistor R1 and can receive the frequency signal from the frequency signal generator 10. The capacitor signal input pin C1 is connected to the capacitor sensor 20 and can receive a capacitor signal from the capacitor sensor 20. The frequency-voltage converter 30 can obtain the current capacitance of the variable capacitor of the capacitor sensor 20 according to the capacitor signal.

The frequency-voltage converter 30 can output a voltage signal to the degree of inclination displaying device 50. A voltage UA of the voltage signal output to the degree of inclination displaying device 50 can be determined according to the following formula:

UA=f*U*R*C,

wherein f is a frequency of the frequency signal received by the frequency signal input pin T, U is the operating voltage received by the operating voltage input pin Vcc, R is a resistance of the resistor R1, C is the current capacitance of the variable capacitor of the capacitor sensor 20.

The degree of inclination displaying device 50 can include a power meter 51, a converting and displaying module 52, a comparator 53, and an indicating device 54.

The power meter 51 is connected to the voltage signal output pin E and can receive the voltage signal from the frequency-voltage converter 30 via the voltage signal output pin E. The power meter 51 can measure the voltage UA of the voltage signal output from the frequency-voltage converter 30.

The converting and displaying module 52 can convert the voltage UA of the voltage signal output from the frequency-voltage converter 30 into a degree of inclination of the electronic device and display the degree of inclination of the electronic device.

A non-inverting input terminal of the comparator 53 is connected to the voltage signal output pin E and can receive the voltage signal from the frequency-voltage converter 30 via the voltage signal output pin E. An inverting input terminal of the comparator 53 is connected to a reference voltage Uref.

An anode of the indicating device 54 is connected to an output terminal of the comparator 53. A cathode of the indicating device 54 is grounded. In one embodiment, the indicating device 54 can be a light-emitting diode (LED).

When the electronic device is actuated to rotate to a limit position, the voltage UA reaches a maximum voltage value which is greater than the reference voltage Uref. The comparator 53 outputs a high-level voltage signal to the anode of the indicating device 54. The indicating device 54 emits light to indicate that the electronic device has moved to its limit position.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A system for outputting a degree of inclination of an electronic device, the system comprising:
a frequency signal generator;
a capacitor sensor attached to an electronic device, the capacitor sensor comprising a variable capacitor having a capacitance which varies in dependence upon the degree of inclination of the electronic device;
a frequency-voltage converter coupled to the frequency signal generator and the capacitor sensor; and
a degree of inclination displaying device coupled to the frequency-voltage converter;
wherein the frequency signal generator is configured to output a frequency signal to the frequency-voltage converter, the capacitor sensor is configured to output a capacitor signal to the frequency-voltage converter, the frequency-voltage converter is configured to output a voltage signal to the degree of inclination displaying device according to the frequency signal and the capacitor signal, and the degree of inclination displaying device is configured to obtain the degree of inclination of the electronic device according to the voltage signal and display the degree of inclination.

2. The system of claim 1, wherein the variable capacitor is a rotary capacitor.

3. The system of claim 2, wherein when the electronic device stands upright relative to a horizontal direction, the capacitance of the variable capacitor reaches a minimum value, and as the degree of inclination of the electronic device increases, the capacitance of the variable capacitor becomes greater.

4. The system of claim 1, wherein the frequency-voltage converter is connected to the frequency signal generator via a resistor and receives the frequency signal from the frequency signal generator via the resistor.

5. The system of claim 4, wherein the frequency-voltage converter is configured to obtain a current capacitance of the variable capacitor from the capacitor signal.

6. The system of claim 5, wherein a voltage UA of the voltage signal output from the frequency-voltage converter is determined according to the following formula:
UA=f*U*R*C,
wherein f is a frequency of the frequency signal, U is an operating voltage of the frequency-voltage converter, R is a resistance of the resistor, C is the current capacitance of the variable capacitor.

7. The system of claim 1, wherein the degree of inclination displaying device comprises a power meter configured to measure a voltage of the voltage signal output from the frequency-voltage converter.

8. The system of claim 7, wherein the degree of inclination displaying device further comprises a converting and displaying module configured to convert the voltage of the voltage signal output from the frequency-voltage converter into a degree of inclination of the electronic device and display the degree of inclination of the electronic device.

9. The system of claim 7, wherein the degree of inclination displaying device further comprises a comparator having a non-inverting input terminal for receiving the voltage signal output from the frequency-voltage converter and an inverting input terminal for receiving a reference voltage, and when the electronic device reaches a limit position, a value of voltage signal is greater than a value of the reference voltage and the comparator outputs a high-level voltage signal.

10. The system of claim 9, wherein the degree of inclination displaying device further comprises an indicating device having an anode connected to an output terminal of the comparator and a cathode grounded, when the comparator outputs a high-level voltage signal, the indicating device emits light.

11. The system of claim 10, wherein the indicating device is a light-emitting diode (LED).

12. The system of claim 1, wherein the frequency signal generator comprises a time-base integrated circuit (IC) chip configured to output the frequency signal to the frequency-voltage converter.

13. The system of claim 12, wherein the time-base IC chip is a MOS555 chip.

14. The system of claim 1, wherein the frequency-voltage converter is a LM2907N chip.
